(19) United States
(12) Patent Application Publication
(10) Pub. No.: US 2013/0288602 A1
(43) Pub. Date: Oct. 31, 2013

(54) CONTENT AWARENESS AND CONTROL AMONG PEER-TO-PEER COMMUNICATION DEVICES

(71) Applicant: Brian J. Spencer, San Diego, CA (US)

(72) Inventor: Brian J. Spencer, San Diego, CA (US)

(73) Assignee: QUALCOMM INNOVATION CENTER, INC., San Diego, CA (US)

(21) Appl. No.: 13/457,120

(22) Filed: Apr. 26, 2012

(51) Int. Cl. H04W 88/02; G06F 15/16

(52) U.S. Cl. 455/41.2; 709/205

(57) ABSTRACT

Apparatus and methods for collaboratively presenting content that is distributed among a plurality of communication devices are disclosed. The method includes initiating, at a host communication device, a peer-to-peer session with other communication devices, and sending a playlist of content to the other communication devices. In addition, information about content listed in the playlist that is currently being presented is also sent to the other communication devices. And at the request of one or more of the other communication devices, digital files that are stored among the other communication devices are added to the playlist. When the digital file is listed at a top of the playlist, the digital file from a corresponding one of the other communication devices is presented.

### FIELD OF THE INVENTION

The present invention relates to communication devices. In particular, but not by way of limitation, the present invention relates to communication devices that intercommunicate in peer-to-peer networks.

### BACKGROUND OF THE INVENTION

Communication devices such as smartphones, netbooks, gaming devices, tablets, netbooks, PDAs, and laptop computers are now ubiquitous. And the capabilities of these communication devices have developed to a level that enables these communication devices to intercommunicate in a peer-to-peer manner.

For example, peer-to-peer communication is now used in connection with gaming (e.g., multi-player gaming), social networking (e.g., users may exchange messages), groupware applications (e.g., information may be synchronized and shared among ad-hoc groups without an external network), proximity based services (information may be broadcast to communication devices when within close proximity), and media entertainment (e.g., remote control and game control).

In many instances, each of a collection of people in a group social setting (e.g., a road trip, barbecue, party, or other social gathering) have a communication device that includes stored content (e.g., music, images, videos, and other types of files) that may be of interested to other people in the group. Although a particular communication device may be connected to a presentation device (e.g., audio amplifier or audiovisual display) to present content that is stored on that particular communication device it is, at best, inconvenient for content stored on other communication devices in the group to be presented on the presentation device.

For example, in the context of a social setting in which people are listening to music from a single audio device (e.g., a sound system) a first communication device may be streaming music from its memory to the audio device via a local connection (e.g., WiFi or Bluetooth), but the other people in the group cannot stream music from their communication devices to the audio device, if at all, without the first communication device being disconnected so another communication device may be connected to the audio device.

Moreover, each of the people on the group is unaware of the content that the other people in the group have on their devices. For example, people at a social gathering do not know what types of music other people have stored on their communication devices. As a consequence, current peer-to-peer communication techniques are often less than ideal and will almost certainly be unsatisfactory in the future.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

Several aspects of the invention may be characterized as a method for collaboratively presenting content that is distributed among a plurality of communication devices. The method includes initiating, at a host communication device, a peer-to-peer session with other communication devices, and sending a playlist of content to the other communication devices. In addition, information about content listed in the playlist that is currently being presented is also sent to the other communication devices. And at the request of one or more of the other communication devices, digital files that are stored among the other communication devices are added to the playlist. When the digital file is listed at a top of the playlist, the digital file from a corresponding one of the other communication devices is presented.

Other aspects may be characterized as a communication device that includes a short-range transceiver to send and receive data via a short-range wireless communication link, a memory to store local content, and a peer-to-peer module in communication with the short-range transceiver that communicates with each of a plurality of peer-to-peer modules in other communication devices to enable the communication device to communicate with the other communication devices. A social content component provides, via the peer-to-peer module and the short-range transceiver, a listing of content stored in the memory to the other communication devices and it receives, via the peer-to-peer module and the short-range transceiver, a plurality of content listings that are each received from a corresponding one of the communication devices to enable the social content component to provide a user of the communication device a view of content available on the other communication devices. The social content component also generates a playlist that includes a listing of content files from the content available on the other communication devices and the local content in the memory of the communication device. And the social content component serially receives and presents each of the content files as each of the content files reaches a top of the playlist.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings where like or similar elements are designated with identical reference numerals throughout the several views and wherein:

FIG. 1 is a block diagram depicting an environment in which exemplary embodiments of the present invention may be realized;

FIG. 2 is a block diagram depicting an exemplary embodiments of communication devices depicted in FIG. 1;

FIG. 3 is a block diagram depicting physical components that may be used to realize the functional components depicted in FIGS. 1 and 2;

FIG. 4 is a flowchart that depicts a method that may be carried out in connection with the embodiments described with reference to FIGS. 1-3; and

FIGS. 5-14 are screen shots from a communication device depicting aspects of user-interfaces that may be utilized in connection with an exemplary embodiment.

### DETAILED DESCRIPTION

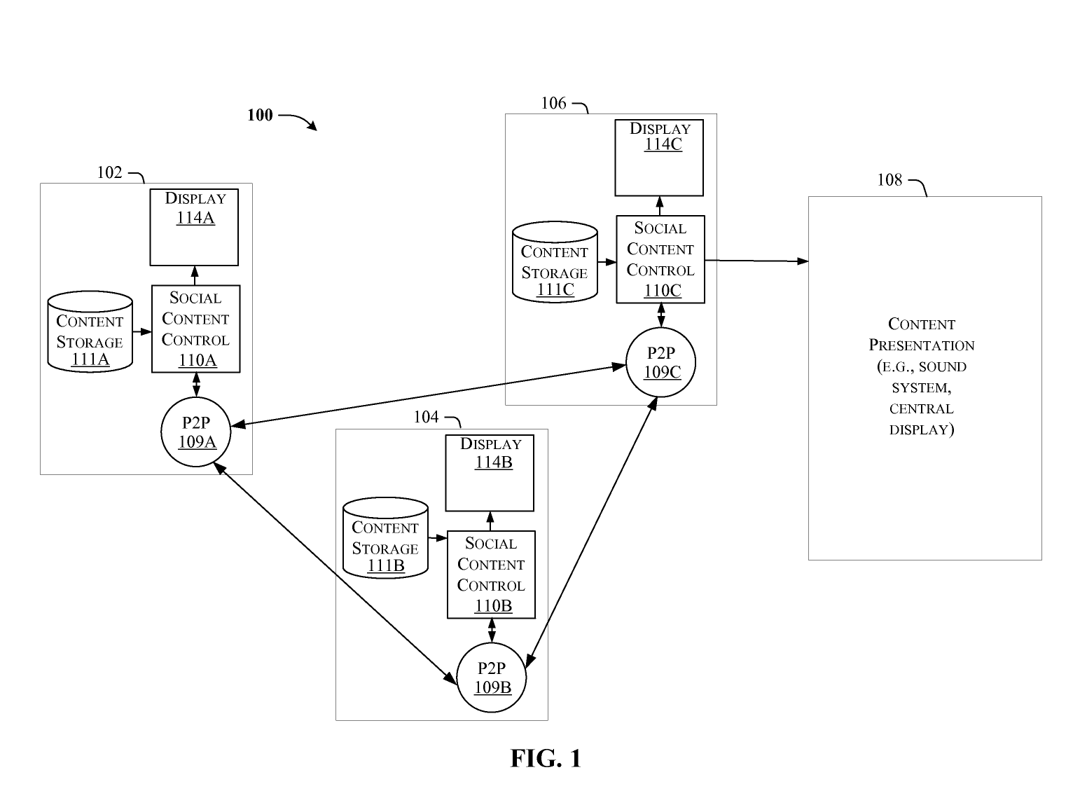

Referring first to FIG. 1, it is a block diagram depicting an exemplary environment 100 in which several embodiments of the present invention may be realized. As shown, each of a first communication device 102, a second communication device 104, and a third communication device 106 (also referred to as a host device 106) are in communication with other ones of the communication devices 102, 104, 106. And in this environment 100, only one of the communication devices 102, 104, 106—communication device 106—is in communication with a content presentation device 108.

In general, the depicted environment 100 is a social environment in which each person, in a group of people, operates one of the communication devices 102, 104, 106. And embodiments of the present invention enable the group of people to collaboratively select, for presentation at the content presentation device 108, a playlist of content files that are distributed among all the communication devices 102, 104, 106. The content files may be audio files (e.g., music files), video files, still image files, and/or other types of files. As discussed further herein, the content presentation device 108 is an optional component because content may also be presented via audio and/or display components one of the communication devices 102, 104, 106.

The communication devices 102, 104, 106 may be realized by any of a variety of types of communication devices including smartphones, netbooks, gaming devices, tablets, netbooks, PDAs, and laptop computers. And the content presentation device 108 may be realized by an audio device (e.g. an audio amplifier and audio transducers), a display (e.g., LCD display), or a device that includes both audio and visual display capabilities (e.g., a high-definition television and surround sound system).

In general, any one of the communication devices 102, 104, 106 may operate as a host (also referred to as a hub) to manage a playlist of content that is distributed among the communication devices 102, 104, 106 and to present the distributed content in the playlist. And any of the communication devices 102, 104, 106 may operate as a client device that has an awareness of content on the other communication devices 102, 104, 106; can affect what content is listed in the playlist; and can control the presentation of the content. But for exemplary purposes, the third communication device 106 operates as the host communication device 106 that manages the playlist and facilitates the presentation of content. In the configuration depicted in FIG. 1 for example, the host communication device 106 presents the content by passing the content to the content presentation device 108, but the host communication device 106 may also have a display and/or audio system to present the content to the people in the group.

Although other architectures may be utilized in connection with the various embodiments described herein, in the environment 100 depicted in FIG. 1, each of the communication devices 102, 104, 106 includes a peer-to-peer module 109A, 109B, 109C that communicates with one or more of the peer-to-peer modules 109A, 109B, 109C on other ones of the communication devices 102, 104, 106. In addition, each of the communication devices 102, 104, 106 includes a social content control component 110A, 111B, 110C that is in communication with a corresponding content storage component 111A, 111B, 111C and a display 114A, 114B, 114C.

In general, the peer-to-peer modules 109A, 109B, 109C interoperate to effectively extend a bus across the communication devices 102, 104, 106; thus creating a single logical bus, which enables each of the social content control components 110A, HOB, 110C in the communication devices 102, 104, 106 to communicate with any of the other social content control components 110A, 110B, 110C. Although several embodiments are described herein as utilizing a software-bus-type architecture (e.g., an Alljoyn-type peer-to-peer architecture described further herein), this is certainly not required, and in other embodiments the content awareness and control schemes disclosed herein may be utilized in connection with other message-passing systems using different architectures.

Each of the social content control applications 110A, 110B, 110C generally operates to enable each of the communication devices to 102, 104, 106 to become aware of content that is collectively available among all the communication devices 102, 104, 106 and contribute to the selection of content that is presented at the content presentation device 108 so that, collaboratively, the group of users of the communication devices 102, 104, 106 may select the content that is presented at the content presentation device 108.

As discussed further herein, in many implementations, the communication devices 102, 104, 106 include a platform (e.g., operating system) to facilitate execution of processor-executable instructions that effectuate the social content control components 110A, 110B, 110C and the peer-to-peer components 109A, 109B, 109. For example, but not by way of limitation, the communication devices 102, 104, 106 may include one of an Android, Ubuntu, Windows, Brew MP, WebOS, or Meego platform.

The physical transport between the communication devices 102, 104, 106 may be any of a variety of technologies and protocols. For example, the communication devices 102, 104, 106, 108 may communicate by Bluetooth, WiFi, or any other transport.

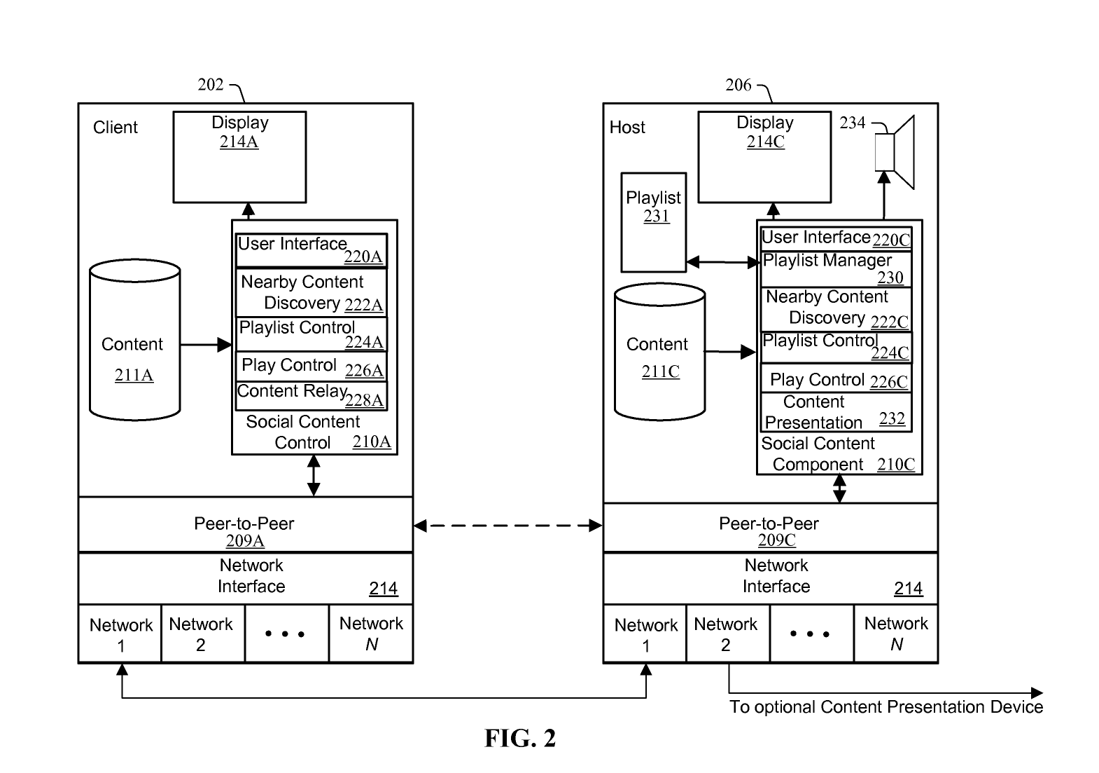

Referring next to FIG. 2, shown are communication devices 202, 206 that may be used to realize the communication devices 102, 104, 106 described with reference to FIG. 1. As shown, the communication device 202 is operating as a client device and the communication device 206 is operating as a host device, but in many embodiments both the communication devices 202, 204 may operate as either client or host communication devices.

As depicted, when operating as a client communication device 202, a social content control component 210A of the communication device 202 includes a user interface 220A, a nearby content discovery component 222A, a playlist control component 224A, a play control component 226A, and a content relay component 228A. As shown, the social content control component 210A is in communication with a peer-to-peer component 209A, a content storage component 211A, and a display 214A. Also depicted is a network interface 214 that couples the peer-to-peer component 209A to N network components.

As shown, when operating as a host, the communication device 206 includes many of the same components as the client communication device 202, but in addition, the social content component 210C of the host communication device 206 includes a playlist manager 230 to manage a playlist 231, and a content presentation component 232 to manage the presentation of content that resides on either the client communication device 202 or the host communication device 206. In addition, an audio transducer 234 is also depicted on the host communication device 206.

The depiction of these components is logical and is not intended to be an actual hardware diagram, and as discussed further herein, each component may be further separated into constituent components, but it should also be recognized that the components may be integrated to such an extent that each component may not be separately recognizable in actual implementation. For example, the depicted division of the social content control components 210A, 210C into constituent components is exemplary only to facilitate a description of the functions that the social content control components 210A, 210C have in the exemplary embodiment, and in actual implementation, there may be separate hardware, firmware, and/or software components that do not exactly correspond to the functional division described with reference to FIG. 2.

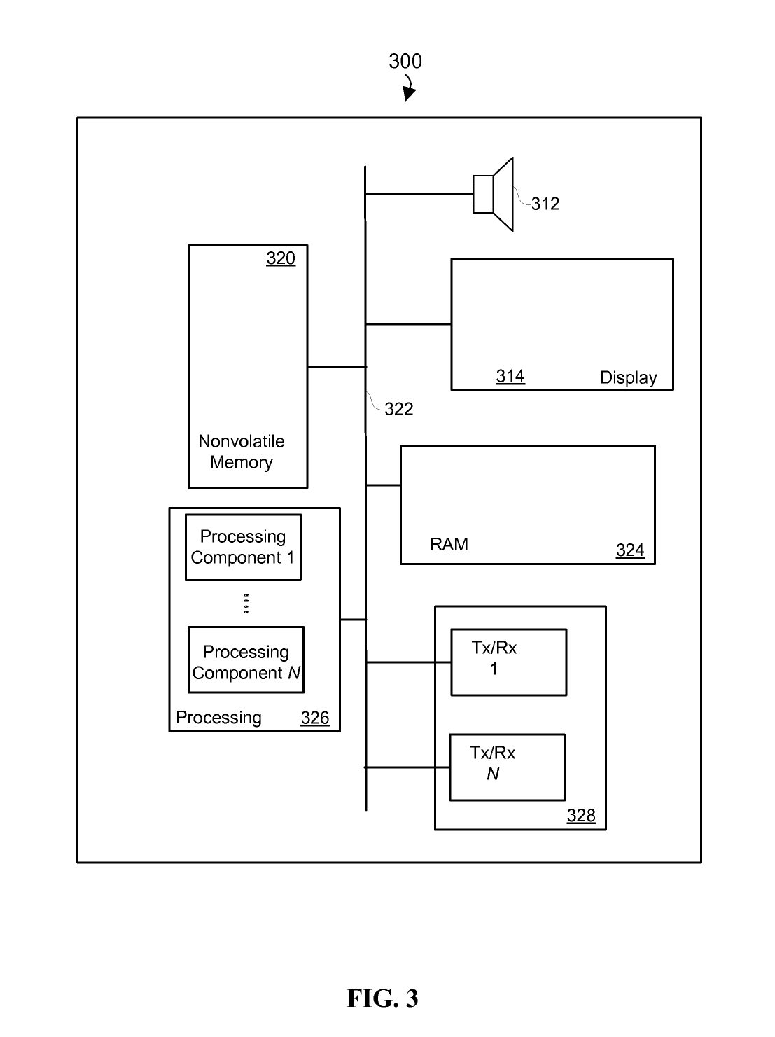

Referring briefly to FIG. 3, shown is a block diagram depicting physical components of an exemplary communication device 300 that may be utilized to realize the communication devices 102, 104, 106 described with reference to FIG. 1 and the communication devices 202, 206 described with reference to FIG. 2. As shown, the communication device 300 in this embodiment includes an audio transducer 312 (e.g., a speaker), a display 314, and nonvolatile memory 320 that are coupled to a bus 322 that is also coupled to random access memory (“RAM”) 324, a processing portion (which includes N processing components) 326, and a transceiver component 328 that includes N transceivers. Although the components depicted in FIG. 3 represent physical components, FIG. 3 is not intended to be a hardware diagram; thus many of the components depicted in FIG. 3 may be realized by common constructs or distributed among additional physical components. Moreover, it is certainly contemplated that other existing and yet-to-be developed physical components and architectures may be utilized to implement the functional components described with reference to FIG. 3.

This display 312 generally operates to provide a presentation of content to a user, and in several implementations, the display is realized by any of a variety of displays (e.g., LCD or OLED displays). And, in general, the nonvolatile memory 320 functions to store (e.g., persistently store) data and executable code including code that is associated with the functional components depicted in FIGS. 1 and 2. In some embodiments for example, the nonvolatile memory 320 includes bootloader code, modem software, operating system code, file system code, and non-transitory processor-executable code to facilitate the implementation of one or more portions of the social content control components 110A, 110B, 110C, 210A, 210C discussed in connection with FIGS 1 and 2 as well as other functional components depicted in FIG. 2. In addition, the playlist 231 may be stored in RAM 324 and the content storage 111A, 111B, 111C, 211A, 211C may be realized by the nonvolatile memory 320.

In many implementations, the nonvolatile memory 320 is realized by flash memory (e.g., NAND or ONENAND™ memory), but it is certainly contemplated that other memory types may be utilized as well. Although it may be possible to execute the code from the nonvolatile memory 320, the executable code in the nonvolatile memory 320 is typically loaded into RAM 324 and executed by one or more of the N processing components in the processing portion 326.

The N processing components 326 in connection with RAM 324 generally operate to execute the instructions stored in nonvolatile memory 320 to effectuate the functional components depicted in FIGS. 1 and 2. As one of ordinarily skill in the art will appreciate, the processing components 326 may include a video processor, modem processor, DSP, graphics processing unit (GPU), and other processing components.

The depicted transceiver component 328 includes TV transceiver chains, which may be used for communicating with external devices via wireless networks. Each of the TV transceiver chains may represent a transceiver associated with a particular communication scheme, and these may be utilized in connection with the remote transport components 212 to communicate with remote communication devices (e.g., via Bluetooth or WiFi).

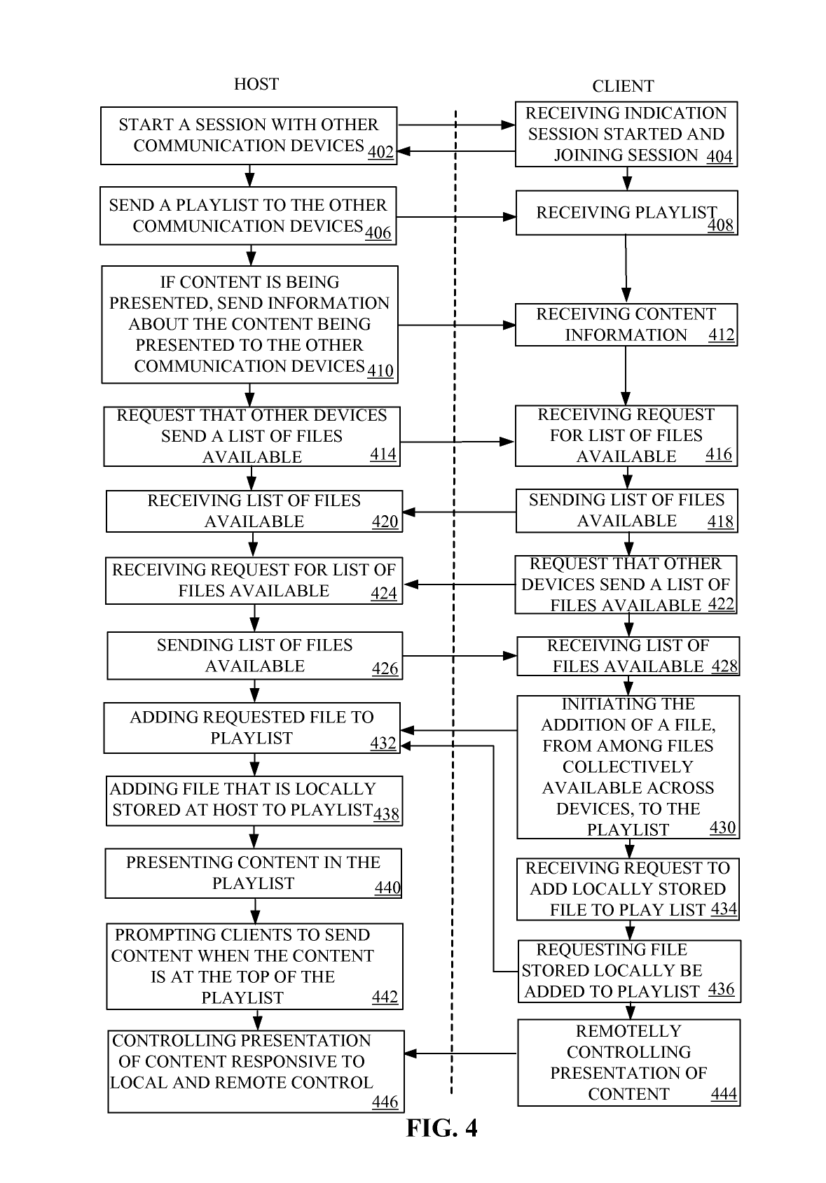

Referring to FIGS. 2 and 4, operation of the exemplary embodiments depicted in FIG. 2 is described. Although FIGS. 2 and 4 are described in connection with an exemplary audio-file (e.g., music) use case, it should be recognized that the embodiments described with reference to FIGS. 2 and 4 are certainly applicable to other use cases including the social presentation of images, video content, and other content that me be presented via an audio transducer and/or visual display to a group of people.

As shown, FIG. 4 separately depicts operations that may be traversed by the host communication device 206 and the client communication device 202. But as previously discussed, in many implementations each of the communication devices 202, 206 may carry out the steps associated with a host or a client communication device depending upon the relative roles that are assumed by each of the communication devices 202, 206; thus, each communication device 202, 206 may include all the functional components depicted in the two communication devices 202, 206.

As depicted, in the exemplary mode of operation, the social content component 210C in connection with the peep-to-peer component 209C of the host communication device 206 initially starts a peer-to-peer session that may be joined by other communication devices including the client communication device 202 (Block 402), and the peer-to-peer component 209A of the client communication device 202 enables the client communication device 404 to join the session in response to receiving an indication that the session has started (Block 404).

Although not required, each of the peer-to-peer components 209A, 209C in this embodiment may be realized by components that are implemented in accordance with peer-to-peer technology that is marketed and distributed under the trade name ALLJOYN. Details of the ALLJOYN technology may be obtained at www/alljoyn.org, which provides several documents including the “Alljoyn Android Environment Setup Guide,” among others, which are incorporated herein by reference. As represented by the dotted line between the mobile communication devices 202, 206, once a session is initiated, the social content control components 210A, 210C intercommunicate as though the two components 210A, 210C were directly connected. The peer-to-peer components 209A, 209C provide many other beneficial functions that are detailed in the above-identified document; thus those details are not repeated herein for clarity.

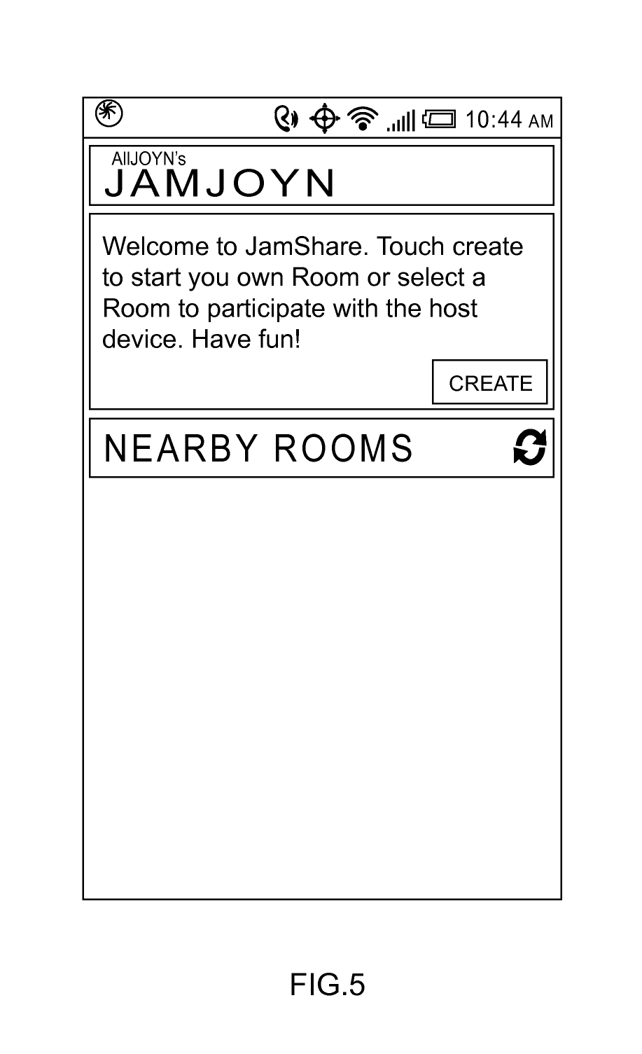

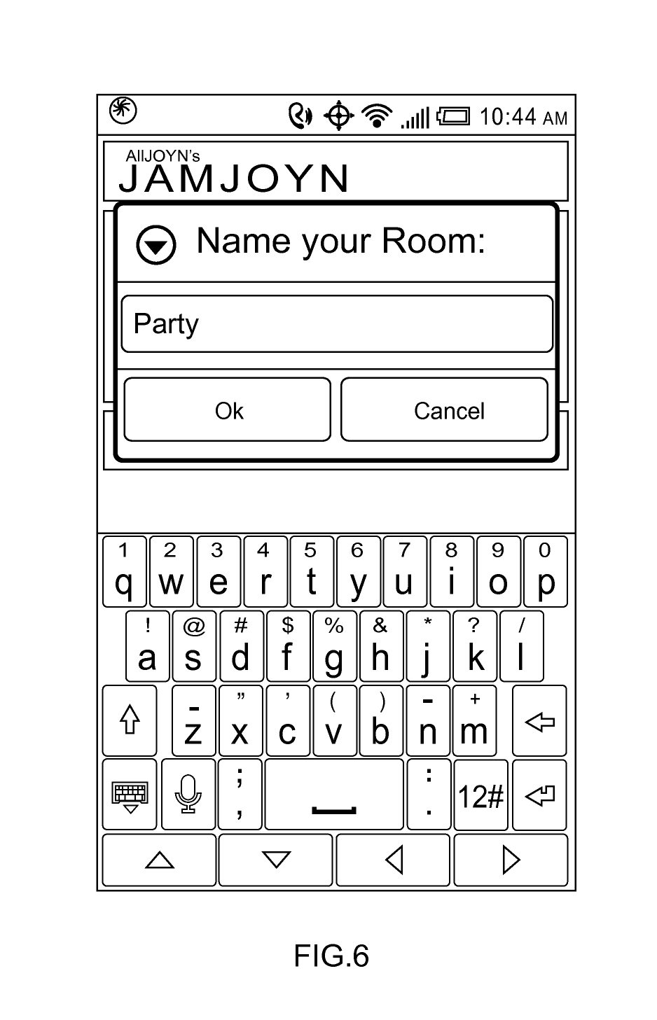

Referring to FIG. 5 for example, shown is a screen shot of an exemplary user interface that may be presented (by the user interface components 220A, 220C) to the users of the communication devices 202, 206 to initiate or join a peer-to-peer session. And FIG. 6 depicts a screen shot of a user interface that enables a user to name the created session.

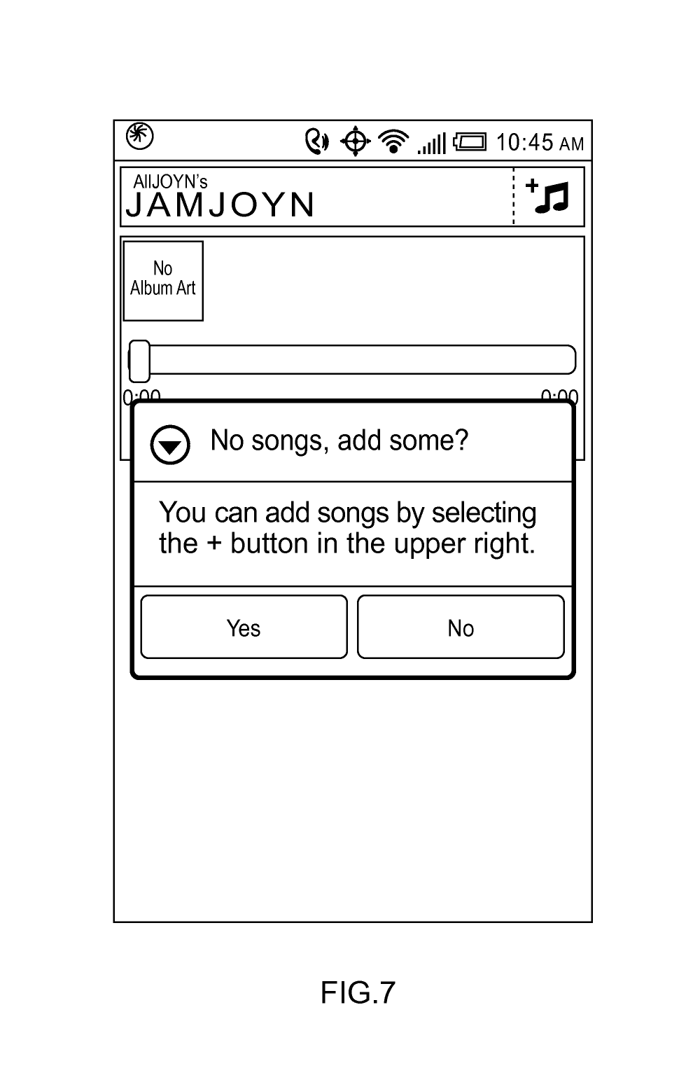

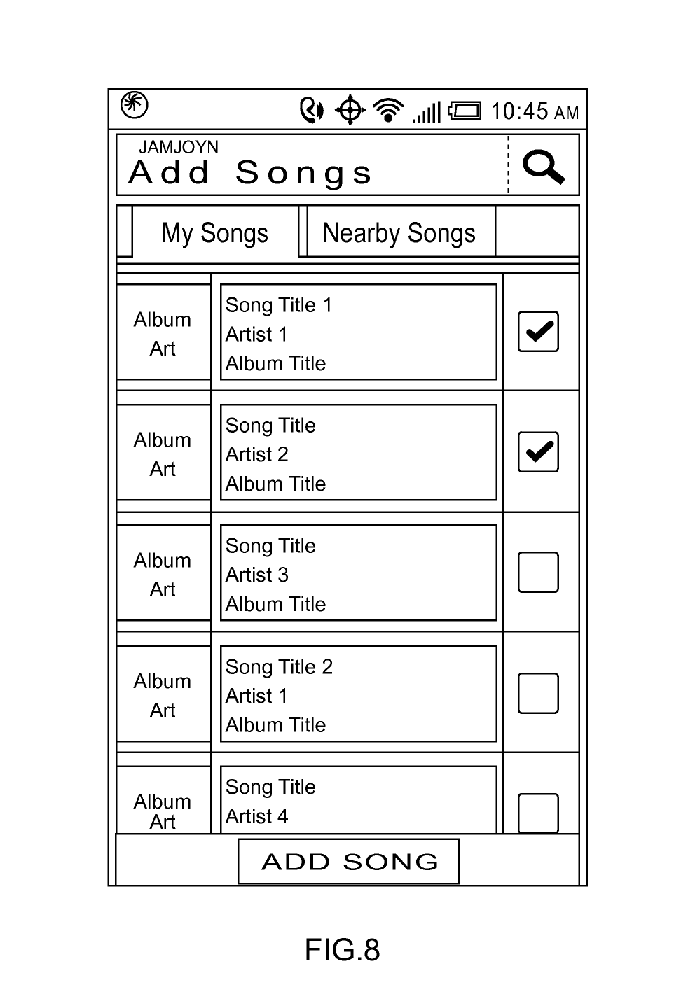

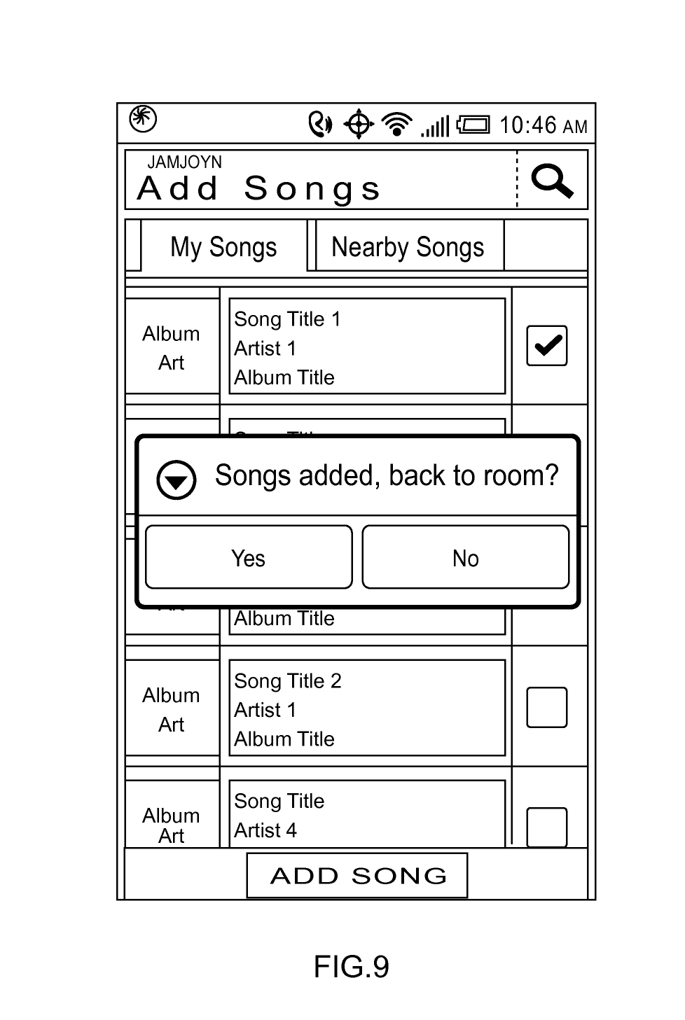

As shown in FIG. 4, once a session has started, the playlist manager 230 of the host communication device 206 sends a listing of files in the playlist 231 (if a playlist has been started at the host 206) to the other communication devices in the session (Block 406). If the playlist 231 has not been initiated, the user interface 220C in connection with the playlist manager 230 enable a user of the host communication device 206 to create and start the playlist 231. Referring briefly to FIGS. 7-9 for example, shown are screen shots of an exemplary prompts that may be presented to a user to create a music playlist from available content (songs) that are stored in the content storage 211C.

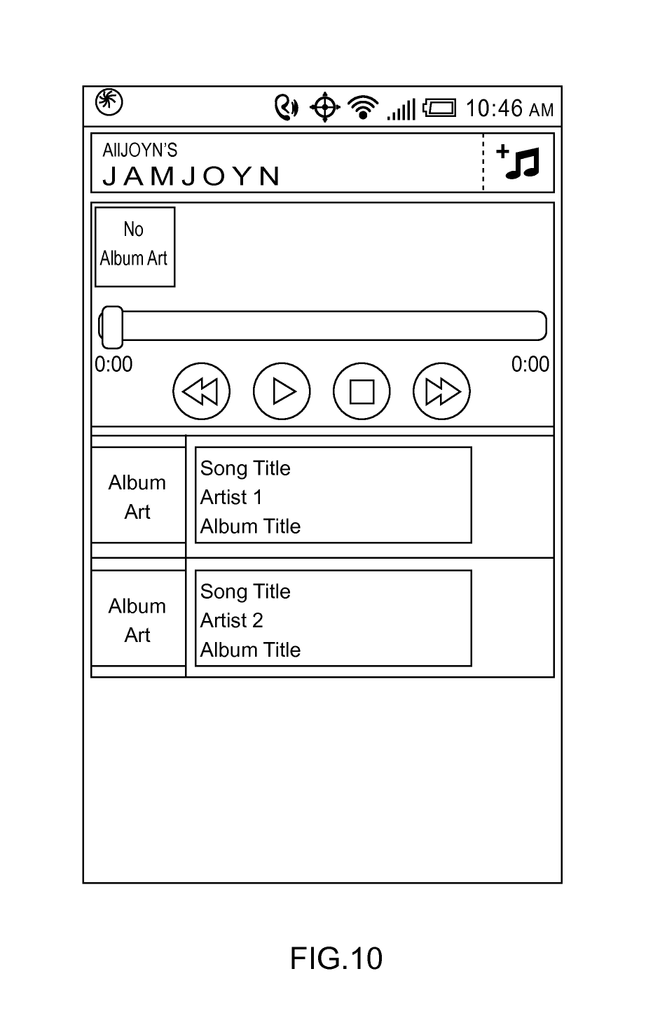

As depicted in FIG. 4, once the playlist 231 is created, the other communication devices, including the client communication device 202, receive the playlist (Block 408), and the user interface 220A presents the listing of files in the playlist to a user of the client communication device 202. Referring briefly to FIG. 10 for example, shown is a screen shot of an exemplary playlist that may be presented to a user of the client communication device 202 and other communication devices.

As shown, the user interface depicted in FIG. 10 also includes controls to remotely control, from the client communication device 102, the presentation of content. Specifically, the user interface includes rewind, play, stop, and fast forward buttons that enable the user of the client communication device 202 to control the corresponding operations at the host communication device 206. In addition, the exemplary user interface depicted in FIG. 10 includes a progress bar that depicts the progress of a content file that is currently being played. It should be recognized that the user interface depicted in FIG. 10 is merely exemplary and that other formats may be utilized, and in addition, when content other than music or video is presented, the user interface need not include the depicted controls or the progress bar.

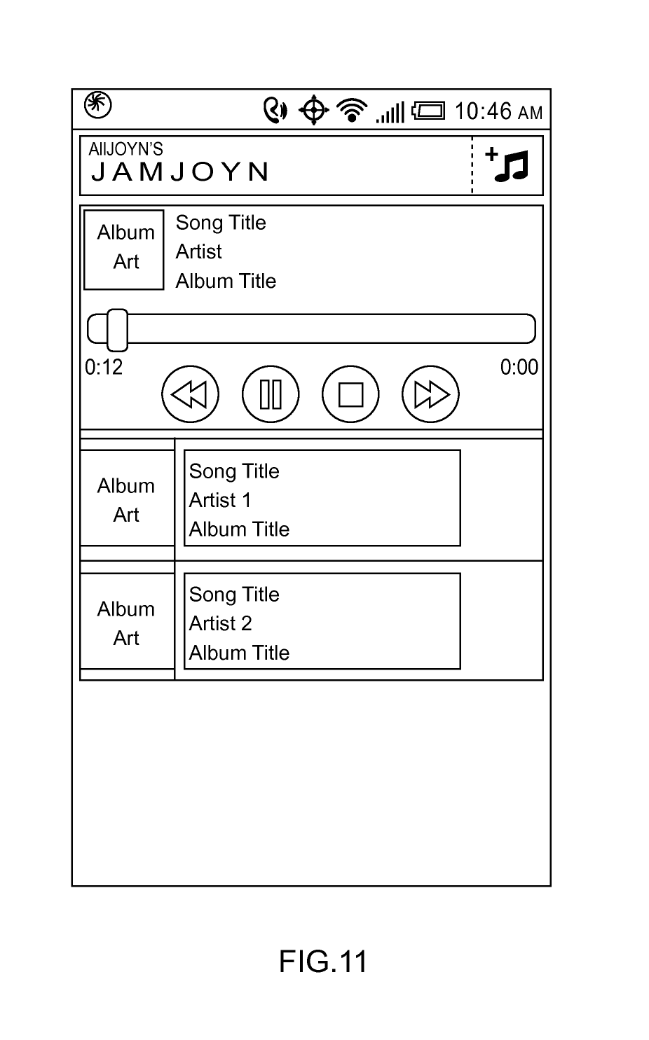

Referring again to FIG. 4, if content is currently being presented by the host communication device 206 (e.g., on the display 214 and/or audio transducer 234 of the host communication device 206 or at a separate device such as the content presentation component 108), then information about the current presentation of content is sent to the other communication devices (Block 410), and this information is received at the client communication device 202 (Block 412) as well as any other client devices that have joined the session. In the context of a music playlist for example, this information may include an artist name, album title, song title, album art (e.g., image data), song length, and current play-progress (e.g., counter information). Referring briefly to FIG. 11, shown is the user interface in FIG. 10, which has been updated with playing information. As shown, the user interface now includes the artist name, album title, song title, album art (e.g., image data), song length, and the current progress of the song play is indicated with the progress bar.

Referring again to FIG. 4, the nearby content discovery component 222C of the host communication device 206 may also request that the other communication devices in the session send a list of files that are available (Block 414), and when the request is received by the client communication device (Block 416), the nearby content discovery component 222A of the client communication device 202 receives the request and sends a list of files that are available in the content storage 211A (Block 418), and the nearby content discovery component 222C in connection with the user interface 220C at the host communication device 206 receives and displays (for a user of the host communication device 206) a list of available files from each of the client communication devices (Block 420).

In addition, the nearby content discovery component 222A of the client communication device 202 enables a user to request that each of the other communication devices (including the host 206) send a list of files that they have available (Block 422), and in response to receiving the request (Block 424), the nearby content discovery component 222C of the host 206 sends a list of files that it has available in the content storage component 211C (Block 426), and the nearby content discovery component 222A in connection with the user interface component 220A of the client communication device 202 receives and displays the list from the host communication device 206 (and lists from other communication devices that are part of the session)(Block 428).

As depicted in FIG. 4, the playlist control component 224A in connection with the user interface 220A of the client communication device 202 enables a user of the client device 202 to initiate the addition of any file to the playlist 231 from among the files that are collectively available across each of the communication devices that are part of the session (including the host communication device 206, the client communication device 202, or any other communication device that is part of the session)(Block 430).

In many implementations for example, the client communication device 202 sends a request to the host communication device 206 to add one or more files-that are collectively available across all the communication devices-to the playlist 231. In alternative implementations, the client communication device 202 sends a request to the particular communication device where the requested file resides, and that particular communication device then sends the request to the host communication device 206. And in response to the request, the playlist manager 230 at host communication device 206 adds the requested file to the playlist 231 (Block 432).

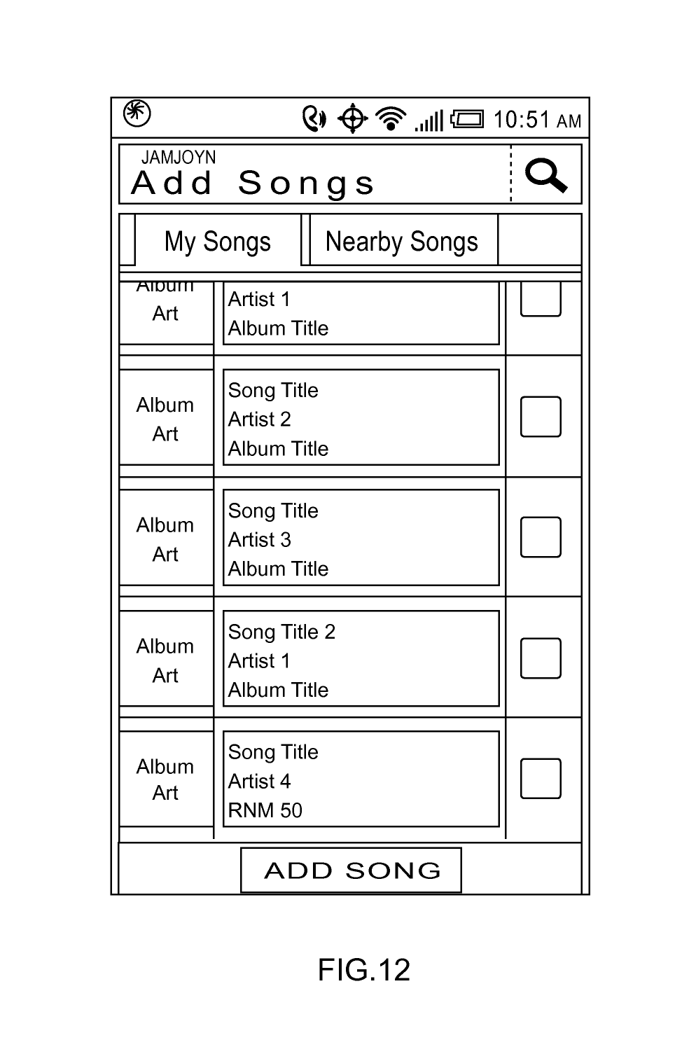

Referring to FIG. 12 for example, shown is a screen shot of a user interface that may be presented to a user that lists files that are available in communication devices that are nearby. When presented with the list of files that are available in nearby devices, the user simply selects the files from the nearby devices that the user would like to add to the playlist 231.

In addition, the client communication device 202 may receive requests from other communication devices (including the host communication device 206) to add files stored locally at the client device 202 (in the content storage 211A) to the playlist 231 (Block 434). And in response, the playlist control component 224A of the client communication device 202 requests that the playlist manager 230 of the host communication device 206 add the requested file that is stored at the client communication device 202 to the playlist 231 (Block 436). And as shown, the playlist manager 230 of the host communication device 206 then adds the requested file to the playlist 231 (Block 432).

A user of the host communication device 206 may also add a file that is stored at the host communication device 206 to the playlist (Block 438). As depicted, the user interface 220C in connection with the playlist control component 224C enable a user of the host device 206 to view and select files in the content storage 211C to be added to the playlist 231, and the playlist manager 230 adds the selected file to the playlist 231.

As shown, a content presentation component 232 at the host communication device 206 functions to present the content in the playlist 231 to the group of people associated with the session (Block 440), and when a particular file is at the top of the playlist 231 (i.e., so it is the file to be played), the host communication device 206 prompts the communication device where the file resides to send the content to the host communication device 206 (Block 442). And the content relay component 228A at the client communication device 202 then provides the content to the host communication device 206. In many embodiments, the content is streamed from the client communication device 202 to the host communication device 206, and the host communication device 206 presents the streaming content as it is received so that files stored at the client devices are not copied at the host communication device 206.

In many implementations, the host communication device 206 may present the content via the audio transducer 234 and/or display 214C that resides within a housing of the host communication device 206, or it may send (e.g., stream) the content to a content presentation device such as a remote audio system and/or a remote display. In this latter implementation, the content presentation component 232 of the host communication device 206 may operate merely to relay the streaming content received from client devices to a separate device (e.g., to the content presentation component 108).

For example, the host communication device 206 may receive streaming audio content from other client devices via a first network transceiver (e.g., WiFi transceiver) (in connection with the network interface 214 and the peer-to-peer component 209C), and the content presentation component 232, in connection with the network interface 214 and a second network transceiver (e.g., a Bluetooth transceiver) facilitates a pass-through of the streaming audio content to a Bluetooth-enabled audio system. In this way, a group of people may add music files to a playlist that is played for the group as a whole in much the same was as people may select music at a typical jukebox. But in the embodiments described herein, the collection of music files is distributed across two or more communication devices.

Referring again to FIG. 4, in many embodiments, the play control component 226A of the client communication device 202 may remotely control the presentation of content (Block 444), and the host communication device 206 controls the presentation of the content responsive to either local control (via the play control component 226C) at the host communication device 206 or responsive to remote control by one or more of the other client communication devices (Block 446). Beneficially, the peer-to-peer components 209A, 209C enable the client device 202 to control selected operations at the host communication device 206 as though the operations were being carried out at the client communication device 202. Details of this type of peer-to-peer control technology are known to those of skill in the art and are available at the above-identified Alljoyn.org website and the associated incorporated-by-reference documents. As a consequence, additional details of the peer-to-peer control are not provided herein.

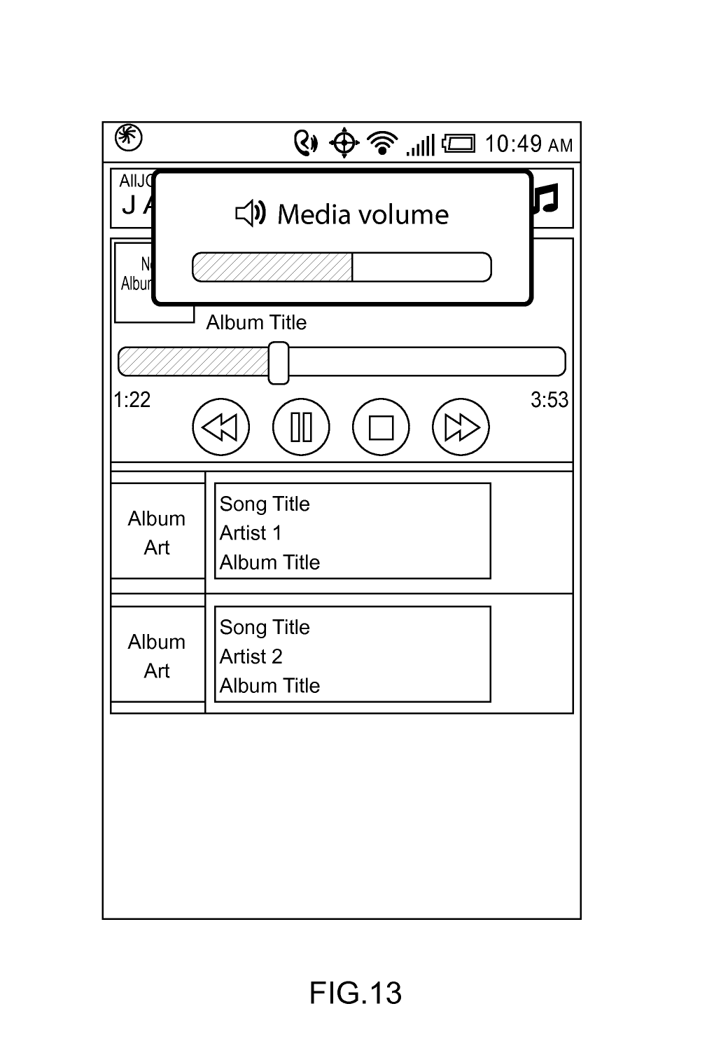

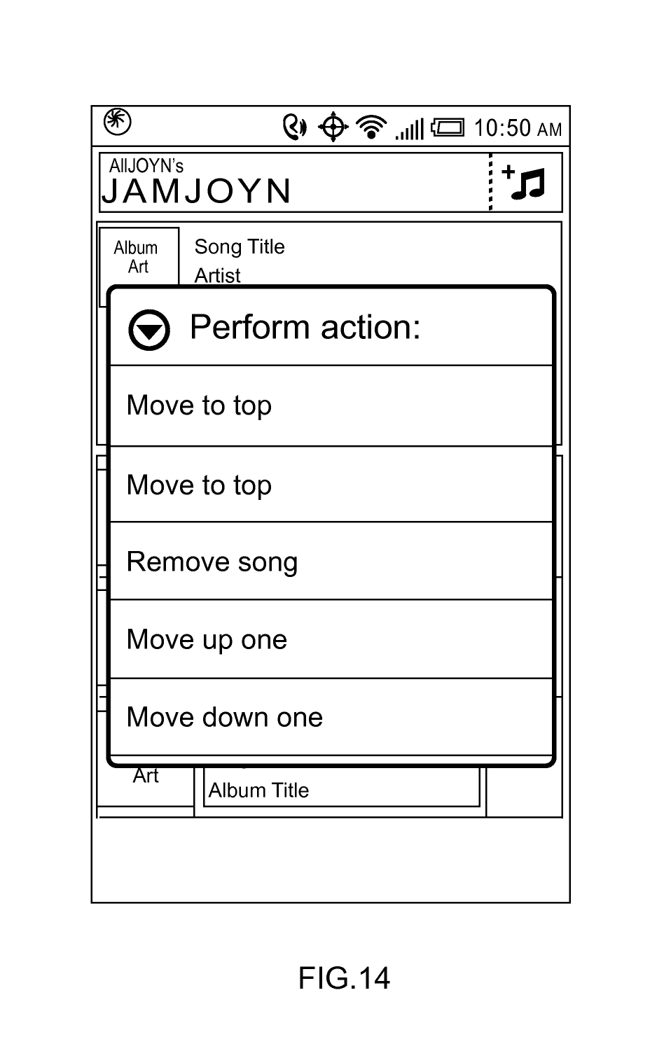

Referring again to the exemplary use-case in which a group of people is joined in a session during which music files are selected and streamed to the host communication device 206 for play in a jukebox-like manner, in some embodiments, each of the people in the group may stop, start, fast forward, rewind, control the volume of the music, and an order of files in the playlist. Referring for example to FIGS. 11, 13, and 14 for example, shown are screen shots of user interfaces that may be presented by the user interface component 220A at the client communication device 202 to control play of music, volume of the music, and an order of the files in the playlist 231. These user-interfaces may be the very same user interfaces provided by the user interface component 220C at the host communication device 206. As a consequence, although not required, in many embodiments each person in the session may control the play of content in the same manner as every other person in the group.

In conclusion, embodiments disclosed herein enable each person in a group of people to select and play content that is distributed among a plurality of communication devices. And in many variations, each of the people in the group may control how the content is played. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A communication device comprising:
a transceiver to send and receive data via a short-range wireless communication link;
a memory to store local content; and
a peer-to-peer module in communication with the short-range transceiver, the peer-to-peer module configured to communicate with each of a plurality of peer-to-peer modules in other communication devices to enable the communication device to communicate with the other communication devices;
a social content component configured to:
provide, via the peer-to-peer module and the short-range transceiver, a listing of content stored in the memory to the other communication devices;
receive, via the peer-to-peer module and the short-range transceiver, a plurality of content listings, each of the plurality of content listings being received from a corresponding one of the communication devices to enable the social content component to provide a user of the communication device a view of content available on the other communication devices;
generate a playlist, the playlist including a listing of content files from the content available on the other communication devices and the local content in the memory of the communication device; and
serially receiving and presenting each of the content files as each of the content files reaches a top of the playlist.

2. The communication device of claim 1, wherein the social content component serially presents the content at the communication device.

3. The communication device of claim 1, wherein the social content component serially presents the content by sending the content to a content presentation device.

4. The communication device of claim 1, wherein the content is selected from the group consisting of audio content, images, and video.

5. The communication device of claim 1, wherein the short-range wireless communication link is selected from the group consisting of Bluetooth, WiFi, Zigbee, and direct WiFi communication schemes.

6. The communication device of claim 1, wherein the content files are received in a streaming format and presented as the content is received.

7. The communication device of claim 1, wherein the social content component is configured to enable the other communication devices to select the content files in the playlist.

8. The communication device of claim 1, wherein the social content component is configured to enable the other communication devices to control the presentation of the content files in the playlist.

9. The communication device of claim 1, wherein the social content component is configured to enable the other communication devices to fast forward, rewind, stop, pause, and control a sound level when the content files in the playlist are presented.

10. A method for collaboratively presenting content that is distributed among a plurality of communication devices, the method comprising:
initiating, at a host communication device, a peer-to-peer session with other communication devices;
sending a playlist of content to the other communication devices;
sending, to the other communication devices, information about content listed in the playlist that is currently being presented;
adding, at the request of one or more of the other communication devices, digital files to the playlist that are stored among the other communication devices; and
receiving and presenting a digital file from a corresponding one of the other communication devices when the digital file is listed at a top of the playlist.

11. The method of claim 10, including:
requesting that the other communication devices send listings of available content to the host communication device.

12. The method of claim 10, including:
controlling the presentation of content based upon commands from one or more of the other communication devices.

13. The method of claim 12, wherein the commands include commands selected from the group consisting of rewind, fast forward, pause, stop, and sound level commands.

14. The method of claim 10, wherein presenting the digital file includes sending the digital file to a content presentation device for presentation at the content presentation device.

15. The method of claim 14, wherein receiving the digital file includes receiving the digital file in a streaming format and presenting the digital file includes passing the digital file in the streaming format through to the content presentation device.

16. The method of claim 10, wherein the content is a content type selected from the group consisting of audio content, video content, and still images.

17. The method of claim 10, wherein the information about the content that is currently being presented includes a play clock.

18. The method of claim 10, including:
sending a list of digital files that are stored on the host device to the other communication devices so the other communication devices may add one or more of the digital files that are stored on the host device to the playlist.

19. The method of claim 10, wherein the a peer-to-peer session is established via a short-range wireless communication link that is selected from the group consisting of Bluetooth, WiFi, Zigbee, and direct WiFi communication schemes.

20. A communication device comprising:
means for initiating, at a host communication device, a peer-to-peer session with other communication devices;
means for sending a playlist of content to the other communication devices;
means for sending, to the other communication devices, information about content listed in the playlist that is currently being presented;
means for adding, at the request of one or more of the other communication devices, digital files to the playlist that are stored among the other communication devices; and
means for receiving and presenting a digital file from a corresponding one of the other communication devices when the digital file is listed at a top of the playlist.

21. The communication device of claim 20, including:
means for requesting that the other communication devices send listings of available content to the host communication device.

22. The communication device of claim 20, including:
means for controlling the presentation of content based upon commands from one or more of the other communication devices.

23. The communication device of claim 22, wherein the commands include commands selected from the group consisting of rewind, fast forward, pause, stop, and sound level commands.

24. The communication device of claim 20, wherein the means for presenting the digital file includes means for sending the digital file to a content presentation device for presentation at the content presentation device.

25. The communication device of claim 24, wherein the means for receiving the digital file includes means for receiving the digital file in a streaming format and means for presenting the digital file includes means for passing the digital file in the streaming format through to the content presentation device.

26. The communication device of claim 20, wherein the information about the content that is currently being presented includes a play clock.

27. The communication device of claim 20, including:
means for sending a list of digital files that are stored on the host device to the other communication devices so the other communication devices may add one or more of the digital files that are stored on the host device to the playlist.

28. The communication device of claim 20, wherein the means for initiating include means for initiating the peer-to-peer session via a short-range wireless communication link that is selected from the group consisting of Bluetooth, WiFi, Zigbee, and direct WiFi communication schemes.

29. A non-transitory, tangible computer readable storage medium, encoded with processor readable instructions to perform a method for collaboratively presenting content that is distributed among a plurality of communication devices, the method comprising:
initiating, at a host communication device, a peer-to-peer session with other communication devices;
sending a playlist of content to the other communication devices;
sending, to the other communication devices, information about content listed in the playlist that is currently being presented;
adding, at the request of one or more of the other communication devices, digital files to the playlist that are stored among the other communication devices; and
receiving and presenting a digital file from a corresponding one of the other communication devices when the digital file is listed at a top of the playlist.

30. The non-transitory, tangible computer readable storage medium of claim 29, the method including:
requesting that the other communication devices send listings of available content to the host communication device.

31. The non-transitory, tangible computer readable storage medium of claim 29, the method including:
controlling the presentation of content based upon commands from one or more of the other communication devices.

32. The non-transitory, tangible computer readable storage medium of claim 31, wherein the commands include commands selected from the group consisting of rewind, fast forward, pause, stop, and sound level commands.

33. The non-transitory, tangible computer readable storage medium of claim 29, wherein presenting the digital file includes sending the digital file to a content presentation device for presentation at the content presentation device.

34. The non-transitory, tangible computer readable storage medium of claim 33, wherein receiving the digital file includes receiving the digital file in a streaming format and presenting the digital file includes passing the digital file in the streaming format through to the content presentation device.

35. The non-transitory, tangible computer readable storage medium of claim 29, wherein the content is a content type selected from the group consisting of audio content, video content, and still images.

36. The non-transitory, tangible computer readable storage medium of claim 29, wherein the information about the content that is currently being presented includes a play clock.

37. The non-transitory, tangible computer readable storage medium of claim 29, the method including:
sending a list of digital files that are stored on the host device to the other communication devices so the other communication devices may add one or more of the digital files that are stored on the host device to the playlist.

38. The non-transitory, tangible computer readable storage medium of claim 29, wherein the a peer-to-peer session is established via a short-range wireless communication link that is selected from the group consisting of Bluetooth, WiFi, Zigbee, and direct WiFi communication schemes.
